(19) United States
(12) Patent Application Publication
(10) Pub. No.: US 2017/0019324 A1
(43) Pub. Date: Jan. 19, 2017

(54) DISTRIBUTED PROCESSING USING CONVEX BOUNDING FUNCTIONS

(71) Applicants: Technion Research & Development Foundation Limited, Haifa (IL); Carmel - Haifa University Economic Corporation Ltd., Haifa (IL)

(72) Inventors: Assaf SCHUSTER, Haifa (IL); Daniel Zvi KEREN, Kiryat-Tivon (IL); Arnon LAZERSON, Kibbutz Ein Carmel (IL)

(21) Appl. No.: 15/208,721

(22) Filed: Jul. 13, 2016

Related U.S. Application Data
(60) Provisional application No. 62/191,602, filed on Jul. 13, 2015.

(51) Int. Cl. H04L 12/26; H04L 29/08; H04L 12/24

(52) U.S. Cl. CPC H04L 43/16; H04L 43/08; H04L 41/14; H04L 41/06; H04L 67/36; H04L 67/10

(57) ABSTRACT

According to some embodiments of the present invention there is provided a computerized device for monitoring of distributed data streams comprising a network interface adapted to send processor instructions to processing nodes. The device comprises a central processor adapted to provide a non-convex function for centralized monitoring of two or more data streams from the processing nodes and compute new processor instructions defining a convex function greater than or equal to the non-convex function over a limited domain. The central processor is adapted to send the new processor instructions to the processing nodes that locally receive at least one data stream and execute the new processor instructions on a local processors.

The local processor analyzes the convex function applied to the locally received data streams and forwards an outcome of the analysis to a centralized monitoring unit when the output value complies with a local predetermined criterion.

### RELATED APPLICATION

This application claims the benefit of priority under 35 USC §119(e) of U.S. Provisional Patent Application No. 62/191,602 filed Jul. 13, 2015, the contents of which are incorporated herein by reference in their entirety.

### FUNDING

The research leading to this invention has received funding from the European Union's Seventh Framework Programme FP7-ICT-2013-11 under grant agreement No. 619491 and No. 619435.

### BACKGROUND

The present invention, in some embodiments thereof, relates to distributed processing and, more specifically, but not exclusively, to distributed processing of non-convex monitoring functions.

As data processing becomes dynamic, large, and distributed, there is increasing demand for what have become known as distributed processing and/or stream algorithms. Such systems continuously collect data to a central server and process the data at the central server using a centralized monitoring condition that generates a response when the defined conditions are met, such as when a monitoring function is greater than a threshold. The data is collected at distributed nodes from many sources, where a processor at each node may also perform initial filtering of some of the data. The data may be stored in a dynamically changing database or be received at each node as a stream of data vectors. For example, a stream of data is two or more data values, such as a data vector, each data vector received at a time point from a continuous stream of time points. Thus, the nodes collect the data at certain times, such as time points, and the data for each time point at each node may be referred to herein as a data vector.

The function that defines the conditions for an alert may be many types of functions, from simple threshold functions to complex data interaction functions. The functions usually define one or more thresholds that when the monitoring function output value for a set of input data vectors meets the threshold condition, a response is generated, such as an alert. The behavior of the monitoring function versus the input data vector may be considered as a multidimensional graph of monitoring function output value versus input data vector value. For simplicity, the illustrative graphs of monitoring functions described in this application are two-dimensional graphs, but it is implied that the input data vector and graphs of monitoring function output values may be multidimensional.

Distributed processing monitoring functions may be applied to input data from the internet of things, sensor networks, big data analytics, distributed web-sites, distributed intrusion detection systems, distributed data communication application, network monitoring systems, such as systems that monitor document streams, text streams, image streams, and/or the like.

### SUMMARY

According to some embodiments of the present invention there is provided a computerized device for monitoring of distributed data streams. The device comprises a network interface adapted to send processor instructions to two or more processing nodes. The device comprises a central processor adapted to provide a non-convex function for centralized monitoring of two or more data streams from the processing nodes. The device comprises a central processor adapted to compute two or more new processor instructions defining a convex function with output values greater than or equal to output values of the non-convex function for a predefined range of input values extracted from two or more previously received data streams. The device comprises a central processor adapted to send the new processor instructions to the processing nodes. The plurality of processing nodes locally receives at least one of the data streams and executes the new processor instructions on a local processor.

The new processor instructions are executed by a local processor to analyze an output value of the convex function based on the locally received data streams as input. The new processor instructions are executed by a local processor to forward an outcome of the analysis to a centralized monitoring unit when the output value complies with a local predetermined criterion.

Optionally, the central processor is further adapted to receive two or more processor instructions for the centralized monitoring and deduce the non-convex function from the processor instructions.

Optionally, the convex function is a tangent function to the non-convex function at a data point within the predefined range.

Optionally, the central processor is further adapted to perform the centralized monitoring.

Optionally, the central processor is further adapted to deduce a central monitoring threshold from the processor instructions, where the new processor instructions further define a local threshold configured for the convex function, and where the local predetermined criterion is the output value of the convex function exceeding the local threshold.

Optionally, the convex function comprises a linear function tangent to the non-convex function and where the non-convex function is a concave function within the predefined range.

Optionally, the convex function comprises a second-degree polynomial function tangent to the non-convex function.

Optionally, the plurality of data streams comprises at least one of a sensor network data, a social network data, a text data, a news data, a channel state information data, a stock market data, a business intelligence data, and a marketing data.

Optionally, the non-convex function is at least one of a Pearson correlation coefficient function, an inner product function, a cosine similarity function, and a join aggregate function.

Optionally, the non-convex function is the subtraction of a first convex monitoring function and a second monitoring convex function, and the convex function is equal to the subtraction of the first convex monitoring function and the tangent function to the second convex monitoring function.

Optionally, the deducing is performed by fitting the non-convex function to an arbitrary monitoring condition defined by the processor instructions.

Optionally, the fitting is a least squares fitting and the non-convex function is a polynomial function.

Optionally, the non-convex function comprises a non-convex shape when viewed from above, and where the convex function comprises a convex shape when viewed from above.

Optionally, the non-convex function is the negative of a non-concave function, where the non-convex function comprises a non-convex shape when viewed from below, where the convex function is the negative of a concave function, and where the convex function comprises a convex shape when viewed from below.

Optionally, the convex function is selected from two or more convex functions by minimizing a number of false alarms for the predefined range, where the number of false alarms are a number of input dataset values that are incorrectly reported by the monitoring.

Optionally, the plurality of data streams each comprise a set of data input values at each of two or more time points received at each of the processing nodes.

Optionally, the set of data input values is retrieved at each of the time points from a dynamically changing database at the time point.

According to some embodiments of the present invention there is provided a computerized device for monitoring of distributed data streams. The device comprises a network interface adapted to receive datasets from two or more processing nodes, where each of the received data set was sent by one of the processing nodes according to processor instructions defining a convex function for locally monitoring at least one data stream. The device comprises a central processor executing processor instructions adapted to receive the datasets from the processing nodes. The device comprises a central processor executing processor instructions adapted to monitor the datasets to determine a violation of a non-convex function. The device comprises a central processor executing processor instructions adapted to execute a response action when the monitoring determines the violation.

According to some embodiments of the present invention there is provided a computer program product for monitoring of distributed data streams, the computer program product comprising a computer readable storage medium having processor instructions embodied therewith. The processor instructions executable by a computer processor to cause the computer to perform a method comprising an action of providing a non-convex function for centralized monitoring of two or more data streams from two or more processing nodes. The method comprises an action of computing two or more new processor instructions defining a convex function with output values greater than or equal to output values of the non-convex function for a predefined range of input values extracted from two or more previously received data streams. The method comprises an action of sending the new processor instructions to two or more processing nodes, where the processing nodes locally receive at least one of the data streams and execute the new processor instructions on a local processor.

The new processor instructions cause the local processor to analyze an output value of the convex function based on the locally received data streams as input. The new processor instructions cause the local processor to forward an outcome of the analysis to a centralized monitoring unit when the output value complies with a local predetermined criterion.

According to some embodiments of the present invention there is provided a computerized method for monitoring of distributed data streams. The method comprises the action of providing a non-convex function for centralized monitoring of two or more data streams from two or more processing nodes. The method comprises the action of computing two or more new processor instructions defining a convex function with output values greater than or equal to output values of the non-convex function for a predefined range of input values extracted from two or more previously received data streams. The method comprises the action of sending the new processor instructions to two or more processing nodes, where each one of the processing nodes locally receives at least one of the data streams and executes the new processor instructions on a local processor. The new processor instructions cause the local processor to analyze an output value of the convex function based on the locally received data streams as input.

The new processor instructions cause the local processor to forward an outcome of the analysis to a centralized monitoring unit when the output value complies with a local predetermined criterion.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention may involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention.

In this regard, the description taken with the drawings makes apparent to those skilled in the art how embodiments of the invention may be practiced.

In the drawings:

FIG. 1 is a schematic illustration of a distributed processing system for computing a convex bounding function, according to some embodiments of the invention;

FIG. 2A is a flowchart for computing a convex bounding function, according to some embodiments of the invention;

FIG. 2B is a flowchart for monitoring a centralized non-convex function after local filtering of datasets by a convex bounding function, according to some embodiments of the invention;

FIG. 3 is a graph of a convex bounding function computed from a non-convex monitoring function, according to some embodiments of the invention;

FIG. 4A is a graph of two convex bounding function computed from a non-convex monitoring function at different points, according to some embodiments of the invention;

FIG. 4B is a graph of a convex upper bound function for a PCC non-convex monitoring function, and a graph of a concave lower bound for the PCC, according to some embodiments of the invention;

FIG. 5A is a table of processing run time results of a convex bounding function compared to geometric monitoring, according to some embodiments of the invention;

FIG. 5B is a table of results of the effect on the chosen function and data on the communication reduction factor of CB over GM, according to some embodiments of the invention;

FIG. 5C is a graph summarizing runtime times for GM and CB, using the various functions and datasets, according to some embodiments of the invention;

FIG. 5D which is a graph of results indicating that the methods which were compared with CB offer a trade-off between communication cost and run-time, according to some embodiments of the invention;

FIG. 5E is a graph summarizing communication required by CB, GM, and RLV for the functions studied as well as SN and FN for the PCA-Score function, according to some embodiments of the present invention;

FIG. 6A is a graph of processing results of a convex bounding function compared to geometric monitoring for a Pearson correlation coefficient of the keyword “Febru”, according to some embodiments of the invention;

FIG. 6B is a graph of processing results of a convex bounding function compared to geometric monitoring for a Pearson correlation coefficient function of the keyword “Bosnia”, according to some embodiments of the invention;

FIG. 6C is a graph of processing results of a convex bounding function compared to geometric monitoring for a inner product monitoring function of the Reuters data, according to some embodiments of the invention;

FIG. 6D is a graph of processing results of a convex bounding function compared to geometric monitoring for a inner product monitoring function of the Twitter data, according to some embodiments of the invention;

FIG. 6E is a graph of processing results of a convex bounding function compared to geometric monitoring for a cosine similarity function, according to some embodiments of the invention;

FIG. 6F is a graph of the inner product value as a function of the number of tweets (time), according to some embodiments of the invention;

FIG. 6G is another graph of processing results of communication cost comparison for a cosine similarity function, according to some embodiments of the invention;

FIG. 6H is a graph of processing results of communication cost comparison for various threshold values for different monitoring methods, according to some embodiments of the invention;

FIG. 7A is a graph of power measurement results for the VOYO® Mini-PC, according to some embodiments of the invention;

FIG. 7B is a graph of power measurements results for the Intel® Edison SoC, according to some embodiments of the invention;

FIG. 8A is a graph depicting the effect of the window size on the communication costs, according to some embodiments of the invention; and

FIG. 8B is a graph depicting the communication cost for monitoring the inner product function on twitter data as a function of number of nodes, according to some embodiments of the invention.

### DETAILED DESCRIPTION

The present invention, in some embodiments thereof, relates to distributed processing and, more specifically, but not exclusively, to distributed processing of non-convex monitoring functions.

Distributed processing systems access databases and/or data streams using distributed processing nodes, and generate a response when a monitoring condition is met. The monitoring condition depends on the data at all of the processing nodes and may contain a monitoring function. Collecting all data vectors to a central processing node and computing the monitoring function at the central processor is impractical because of the high network communication loads in aggregating the data. Further, the processing requirements at the central computer require long computation times. With the advent of data stream processing systems, a variant of this problem assumes that the data at the nodes is also dynamic. Continuously computing the monitoring function's value is typically infeasible, as real-world data consists of many nodes, each holding a large, rapidly changing data stream and/or database. This leads to the introduction of the distributed monitoring problem, also referred to as the functional monitoring problem. This problem is difficult to solve as being nondeterministic polynomial time (NP) complete even in very simple scenarios.

An algorithm, which may reduce communication load in distributed processing systems, is geometric monitoring (GM). The GM method, as described by Sharfman et al. in “A geometric approach to monitoring threshold functions over distributed data streams”, published in Association for Computing Machinery Transactions on Database Systems volume 32 issue 4 article 23 from November 2007, incorporated herein by reference, is a general method and may handle a wide range of conditions. Applying GM in many cases is computationally very demanding, as it requires solving a complex geometric problem—computing the distance between a point and a surface, such as a non-convex surface—which is often very time-consuming even in low dimensions. Thus, while useful for reducing communication, GM often suffers from heavy computational burden at each node and in many cases, the runtime requirements of the GM method at each node render it unusable.

Since processing distributed data at a central computer incurs very high communication and computation complexities, defining local processing conditions at each node, such that when they are maintained some global condition holds, may improve the network communication load and computational complexity.

Moreover, GM is unsuitable for use in systems in which deployed nodes are resource-contrained, for example, ubiquitous nodes that include sensors used in smart cities and/or systems designed for the Internet of Things (IoT). Such nodes (also referred to herein as thin nodes) have reduced processing capabilities, small memory, and limited local storage. Moreover, the nodes may communicate over wireless communication channels, and/or may be powered by batteries with limited lifespan and/or energy capacity. The systems and methods described herein may be implemented in such thin nodes, by providing efficient use of processors, memory, storage, and power.

According to some embodiments of the invention, there are provided systems and methods for distributed processing of data with a non-convex monitoring function by computing a convex bounding function for processing the data at each node. In a distributed processing system with many computing nodes, each node receives a continuous local stream of data, such as a database originated stream, a sensor array, and/or the like. Computer instructions are received at a central processing computer, where the computer instructions define a monitoring condition containing a non-convex monitoring function and optionally a threshold. A convex bounding function is computed that defines upper bounds of the non-convex monitoring function, such that output values of the convex bounding function are greater than or equal to output values of the non-convex monitoring function for a predefined range of input values. The convex bounding function is distributing to each processing node to determine when local data streams may match the monitoring condition. When the local data vector received at a node produces a convex bounding function output value greater than a threshold, a response is generated, such as transferring the data vector to the central computer, presenting an alert, and/or the like. Using the convex bounding function greatly reduces the network communication load of transferring all data to the central computer, reduces the computational load at the central computer processor, and/or reduces the power requirements of the nodes transferring the data to the central computer and/or reduces the power requirements of the central computer.

As used herein, the term a convex function is a continuous function with all eigenvalues of its Hessian greater than or equal to zero over a local data vector region. As used herein, the term a non-convex function means a function that is not a convex function.

It is noted that the convex function referred to herein may sometimes be interchanged with a set of points.

A set is convex if and only if (iff) it satisfies the condition: if two points are inside the set, so is a line segment between the two points. A function is convex if and only if the region above its graph is convex.

A formal definition is provided for convexity:
A convex combination of points uᵢ in Euclidean space is an expression of the form Σᵢλᵢuᵢ, where the λᵢ's are positive scalars whose sum equals 1.
A set is termed convex if it contains all the convex combinations of all its finite subsets.
The convex hull of a set B is the smallest (with respect to inclusion) convex set which contains B.
A real-valued function f is termed convex iff, for every convex combination Σᵢλᵢuᵢ, the following hold: f(Σᵢλᵢuᵢ)≦Σᵢλᵢf(uᵢ).
For every convex function and every threshold T, the set {u|f(u)≦T} is convex.
f is termed concave iff (−f) is convex.
If f is convex (or respectively concave), flies above (or respectively below) all its tangent planes.

As used herein, the term non-convex monitoring function means a non-convex function that is applied to distributed data as part of a monitoring condition and/or rule.

In a mathematical analogy, f denotes a non-convex monitoring function to be applied to data vectors and T denotes a threshold such that when the function value is greater than the threshold a response is generated. For example, when f(u)>T for some given threshold T and data vector u, a response is generated. The system-wide condition f<=T is used to compute a local convex bounding function, denoted g, such that g>=f over a local domain. When the condition g<=T is met then the condition f<=T is also met. The convex bounding function may be processed locally by each processing node and as long as the local condition holds, there is no system-wide monitoring condition requiring a response.

In embodiments of the invention, a non-convex monitoring function f is the difference of two convex functions f=c1−c2, and a convex bounding function is computed as c=c₁−lc₂(p₀), where lc₂(p₀) denotes the tangent plane to c₂ around p₀, where p₀ denotes an average data vector at a particular time. In this example embodiment g denotes a convex bounding function such that f<=g, and each node may locally monitor the convex condition g<=T.

Optionally, in some embodiments of the invention, a non-concave monitoring function f and a condition f≧T may be monitored by similarly computing a concave lower bounding function. For example, the non-convex monitoring function is the negative of a concave function, and a convex bounding function is the negative of concave bounding function. For example, the monitoring function is a non-concave function when viewed from above and when viewed from below it is a non-convex monitoring function. For example, the concave bounding function is concave when viewed from above and when viewed from below it is a convex bounding function.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

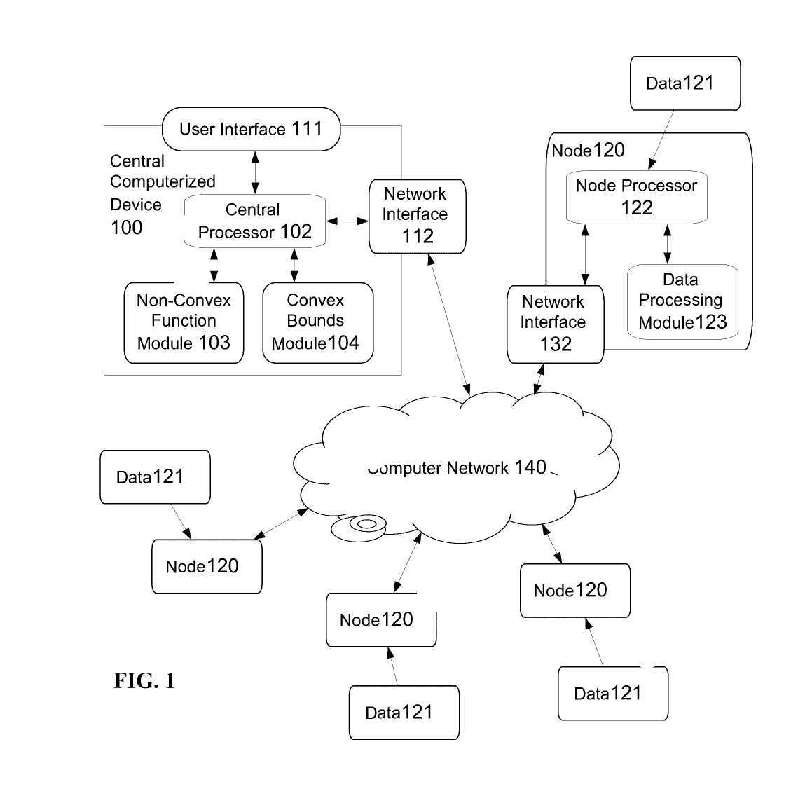

Reference is now made to FIG. 1, which is a schematic illustration of a distributed processing system for computing a convex bounding function, according to some embodiments of the invention. A central computerized device 100 receives processing instructions for distributed processing at two or more nodes 120. The central computerized device 100 comprises a central processor 102 configured to process instructions of a non-convex function module 103 that adapts the processor 102 to determine a non-convex monitoring function, such as from received processor instructions, from a received explicit non-convex function, from a numerical expression in a programming language, and the like. The central processor 102 is adapted to process instructions of a convex bounds module 104 that compute new processor instructions defining a convex bounding function from the non-convex monitoring function, and send, using a network interface 112 and the computer network 140, the new processor instructions to two or more processing nodes 120 for distributed processing of data 121. Each processing node 120 comprises a node processor 122 for processing instructions received from the data processing module 123 and the central processor 102 through the node's network interface 132, such as the new processor instructions defining a convex bounding function. The node processors 122 then receive data 121 and apply the new processor instructions to the data 121. When the data 121 at a node matches the convex bounding function output value to a threshold, that node generates a response, such as sending the matching data to the central processor for further processing and/or presenting an alert to a user interface 111.

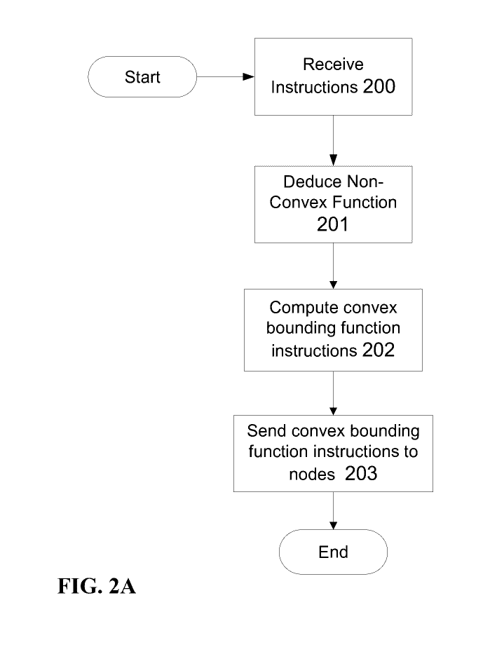

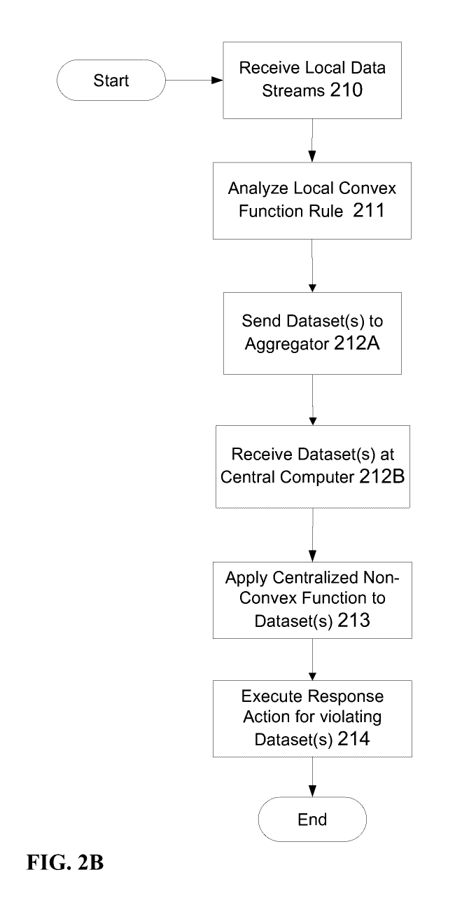

Reference is now made to FIG. 2A, which is a flowchart for computing a convex bounding function, according to some embodiments of the invention. A central processor 102 receives 200 processing instructions for monitoring data 121 received at distributed nodes 120. The central processor 102 may deduce 201 from the processing instructions a non-convex monitoring function, denoted f, and a threshold, denoted T, such that when f<=T for a certain input data vector the processor generates a response. Such as response may be a data violation alert, an alert to a user interface 111, activating processing instructions of an alert module, and/or the like.

Optionally, when a local violation occurs (i.e., f(p₀+dᵢ)>T), the respective node 120 notifies central processor 102. Central processor 102 may attempt to resolve the violation by searching for a subset of nodes 120 (which contains the violating node), whose local vectors balance each other (i.e. the value of the bounding function evaluated at their average is below the threshold). A lazy recovering scheme may be implemented, in which central processor 102 gradually gathers local vectors until the violating nodes are balanced.

The central processor 102 computes 202 new processor instructions defining a convex bounding function, denoted g, from f that is greater than or equal to f in a region of the received input data vector 121 values.

Computing convex bounds for a non-convex monitoring function by the convex bounds module 104 relies on the observation that, when f denotes a convex monitoring function and f(vᵢ)≦T holds at every node i, where vᵢ denotes the data vector for that time point and node, it also holds that f(average_{over nodes}(vᵢ))≦T. Thus, monitoring a convex monitoring function at distributed nodes, where convex is defined as viewed from above, guarantees that if a system-wide monitoring violation occurs a local violation also occurs at the node.

To handle a general monitoring function denoted f, such as non-convex monitoring function deduced by a non-convex function module 103, in embodiments of the present invention the central processor 102 computes a convex bounding function g such that g(vᵢ)≧f(vᵢ) for all data vectors vᵢ. This may yield a simple monitoring condition, g≦T, whose correctness implies the correctness of the desired condition f≦T. The convex bounding function g may be easy to derive and calculate by the central processor 102, and may tightly bound f to avoid false alarms. Therefore, to monitor arbitrary functions, such as non-convex monitoring functions, computing a convex bounding function by the central processor 102, as opposed to seeking a geometric solution, may simplify monitoring by distributed processing systems. The arbitrary monitoring function determined by the central processor 102, denoted f, is relaxed to a convex bounding function g that bounds f from above, and the distributed processing nodes monitor the condition g≦T. This condition implies f≦T and is easy to compute by the node processors. The function g may be referred to as a convex bounding function for a non-convex monitoring function f.

Optionally, a non-convex function is fitted by regression analysis to an arbitrary function by the central processor 102. For example, a polynomial function of degree n is fitted by regression analysis to an arbitrary function, such as a look up table function, using a least squares fitting method. Optionally, other fitting methods are used, such as least square distance, least absolute deviations, least absolute shrinkage and selection operator (LASSO), and the like. Optionally, other non-convex functions are fitted to an arbitrary function, such as a cosine series, a Taylor series, a trigonometric function, and the like.

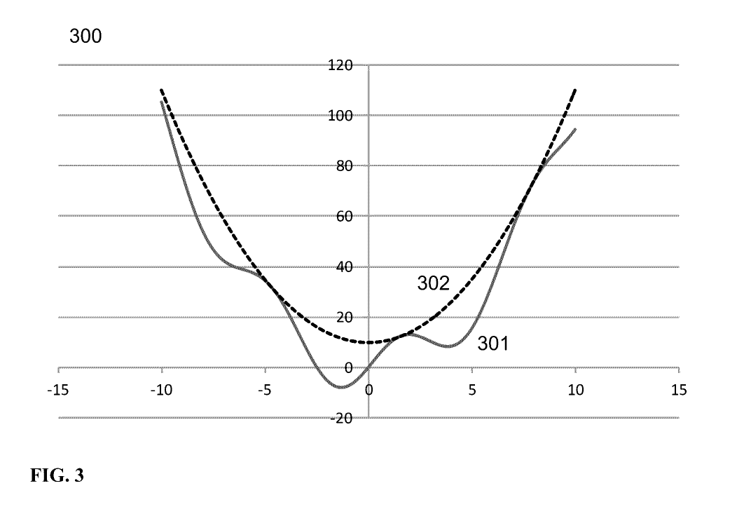

Reference is now made to FIG. 3, which is a graph of a convex bounding function computed from a non-convex monitoring function, according to some embodiments of the invention. In the graph 300 the non-convex monitoring function 301 determined by the central processor 102 is a solid line deduced as equation x²+10 sin(x) which is bounded from above by a convex bounding function 302 determined by the central processor 102 as the equation x²+10. The number of convex bounding functions may be infinite and the convex bounding function to use at a node is selected from all possible bounding functions such that it is the function with minimum output values over the region of input data vectors, denoted vᵢ, received at one or more nodes. For example, a tangent plane to the concave monitoring function f at data vector equal to average(vᵢ) defines a convex bounding function in the region. Since every tangent plane is linear, it is also convex. Further, a concave function lies under any of its tangent planes.

A false alarm may occur when for a data vector u, T≧f(u) and T<g(u).

Optionally, to minimize the number of false alarms, the density-weighted range of data vectors where a false alarm occurs, such as where f(u)>g(u), is minimized by the central processor 102 when selecting the convex bounding function g. For example, when a distribution of data vectors occurs over a range from p₁ to pₙ, the integral of the distribution data vectors over the range where f(u)>g(u) is a value that when minimized, minimizes the false alarms.

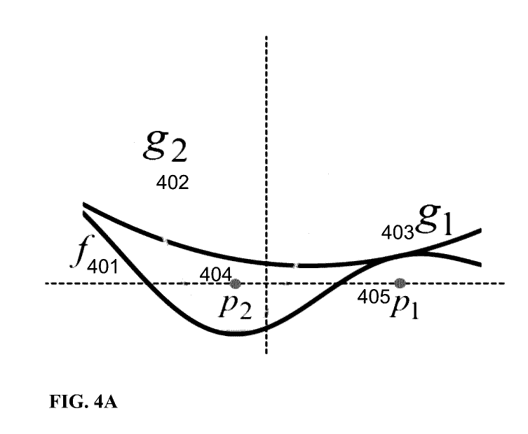

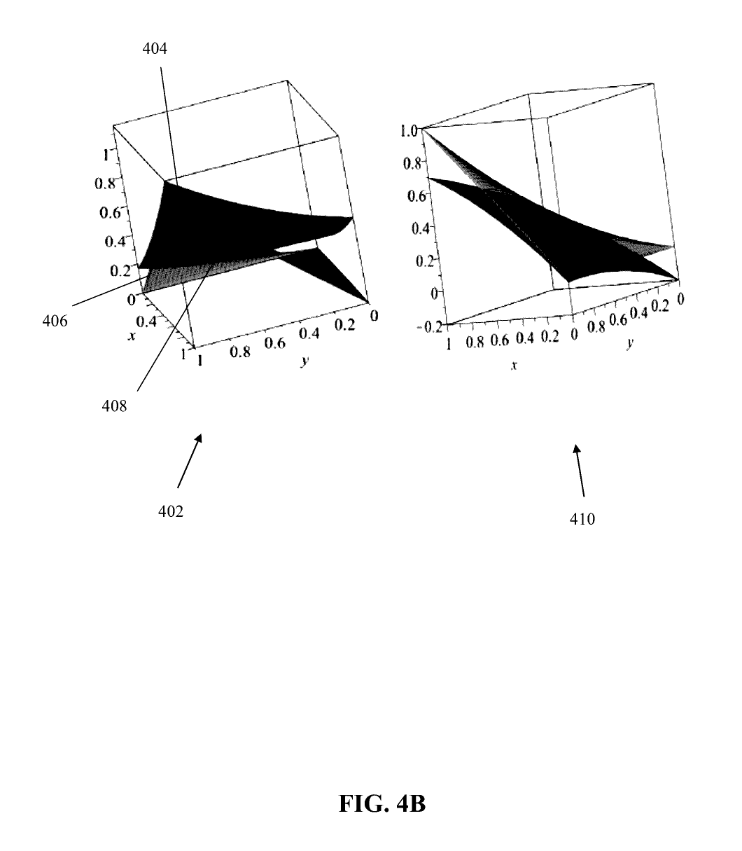

Reference is now made to FIG. 4A, which is a graph of two convex bounding functions computed from a non-convex monitoring function at different points, according to some embodiments of the invention. For a non-convex monitoring function f 401, a convex bounding function g₁ 403 is suitable bounding function at the data vector region around p₁ 405 and the convex bounding function g₂ 402 is suitable bounding function at the data vector region around p₂ 404.

When a monitored function denoted f is convex, the choice of a convex bounding function by the central processor 102, denoted g, is trivial, such as g=f.

When f is concave, the tangent plane at p₀ is the optimal candidate determined by the central processor 102 for g around p₀. For the general case when f=c₁−c₂, where both c₁ and c₂ are convex, the condition f≦T may be defined by a convex bounding function c=c₁−Lc₂(p₀)≦T , where Lc₂(p₀) is the tangent plane of c₂ at p₀. For example, when f possesses bounded second derivatives over a domain it may be described as the difference between two convex functions. In this example, c is convex, bounds f from above, and that the definition of c is motivated by the special cases where f is an arbitrary monitoring function deduced by the central processor 102. Optionally, the lower bound case is similarly handled when the inequality f≧T is replaced by the condition Lc₁(p₀)−c₂≧T. In this example Lc₁(p₀)−c₂ is concave and bounds f from below.

Optionally, a non-convex monitoring functions f is expressed as the difference of two convex functions. A function is convex in a given domain D when its Hessian is positive semi-definite (PSD) at every point in D. When f possesses bounded second derivatives over a domain D, it may be expressed as the difference of two convex functions. Since the elements of the Hessian of f, denoted H_{f}, are bounded over D, there is a lower bound on H_{f}'s eigenvalues, denoted Λ. In the equations:

$${c}_{1} ( u ) = f ( u ) + \frac{Λ}{2} {‖ u ‖}^{2} , {c}_{2} ( u ) = \frac{Λ}{2} {‖ u ‖}^{2}$$

f=c₁−c₂ and c₂ is positive definite. Also, H_{c1}=H_{f}+H_{c2}=H_{f}+ΛI, where I is the identity matrix. Therefore, all the eigenvalues of H_{c1} are greater than or equal to zero and c₁ is convex. Since c₁−c₂≦T, the monitored condition is given as an inequality between two convex functions c₁≦T+c₂. This condition may be converted to convex form by the central processor 102 replacing the monitoring condition with c₂≦L_{c1}(p₀), where L_{c1}(p₀) is c₁'s tangent plane at p₀.

Reference is again made to FIG. 2A. The central processor 102 sends 203 the computed local processor instructions comprising the convex bounding function to two or more nodes 120 using network interfaces 112 and 132 and a computer network 140.

Reference is now made to FIG. 2B, which is a flowchart for monitoring a centralized non-convex function after local filtering of datasets by a convex bounding function, according to some embodiments of the invention. The distributed processing nodes receive 210 local data streams and analyze 211 the convex bounding function rule using the sent 203 local processor instructions. When one or more dataset(s) of the data stream matches the convex bounding function rule, the dataset(s) is sent 212A to a central aggregating computer that receives 212B the dataset(s) suspected of violating the global non-convex monitoring function. The central computer applies 213 the non-convex monitoring function to the dataset(s) by executing the processor instruction defining the global monitoring rule, and when the global monitoring condition is violated the central computer executes 214 a response action according to the rule.

Optionally, the central processor that computes the new processor instructions defining the convex bounding function as described in the method of FIG. 2A belongs to a different server and/or computer than the central processor that aggregates the data streams to perform the monitoring as described in the method of FIG. 2B.

Following are example applications of embodiments according to the present invention using data from Reuters Corpus RCV1-v2 (Reuters data), a Twitter crawl Dataset-UDI-TwitterCrawl-August 2012 (Twitter data), and the 10 percent sample supplied as part of KDD Cup 1999 Data (KC). Reuter's data consists of 804,414 news stories, produced by Reuters between Aug. 20, 1996, and Aug. 19, 1997. Each Reuter's story is categorized according to its content, and identified by a unique document ID. A total of 47,236 features were extracted from the documents and then indexed. Each document is represented as a data vector of the features it contains. Ten data streams were simulated by arranging the feature vectors in ascending order according to their document ID, and selecting feature data vectors for the streams according to a round-robin algorithm. Twitter data is a subset of Twitter posts containing 284 million follower relationships, 3 million user profiles, and 50 million tweets. The dataset is filtered to obtain only hashtagged tweets, leaving 9 million tweets from 140,000 users. For each tweet, the dataset contains information about the tweet content, tweet ID, creation time, re-tweet count, favorites, hashtags and universal record locators (URLs).

KC was used for the Third International Knowledge Discovery and Data Mining Tools Competition. The original task was to build a network intrusion detector. The dataset contains information about TCP connections. Each connection is described by 41 features, such as duration, protocol, bytes sent, and bytes received.

For all data sets, in order to simulate multiple streams, the data is distributed between the nodes in round-robin fashion. Results are presented for 10 streams, and some results are presented for communication reduction for up to 1,000 streams (note the reduction in computational overhead does not depend on the number of streams).

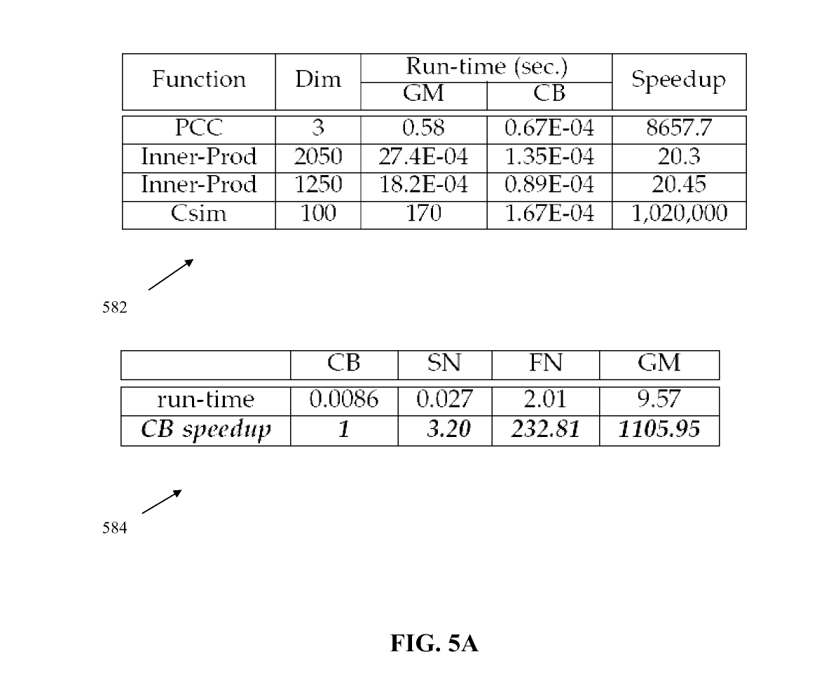

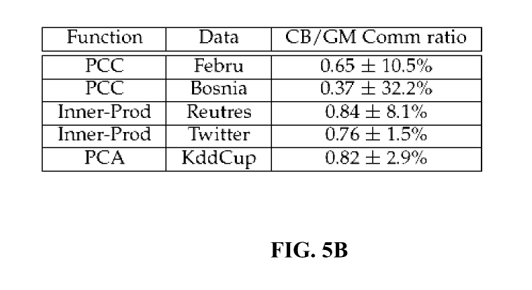

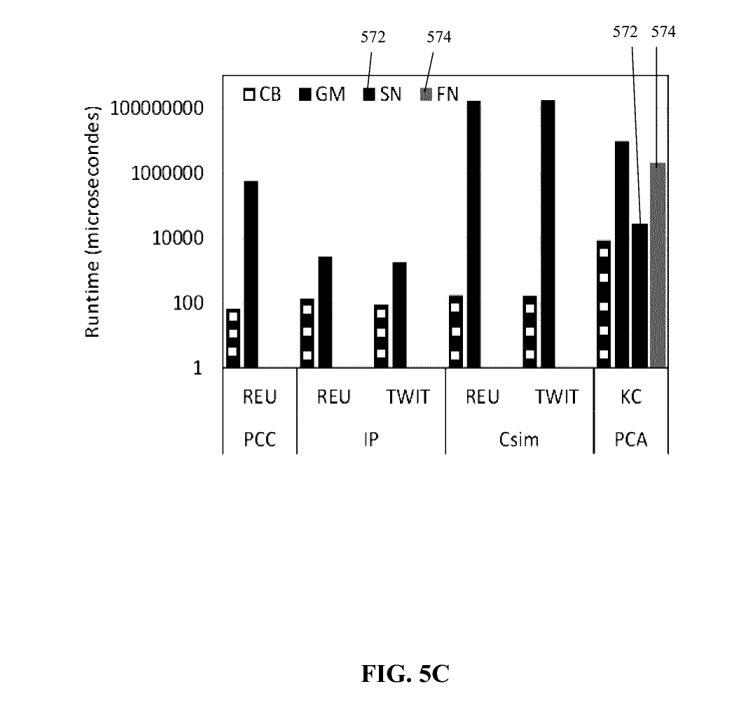

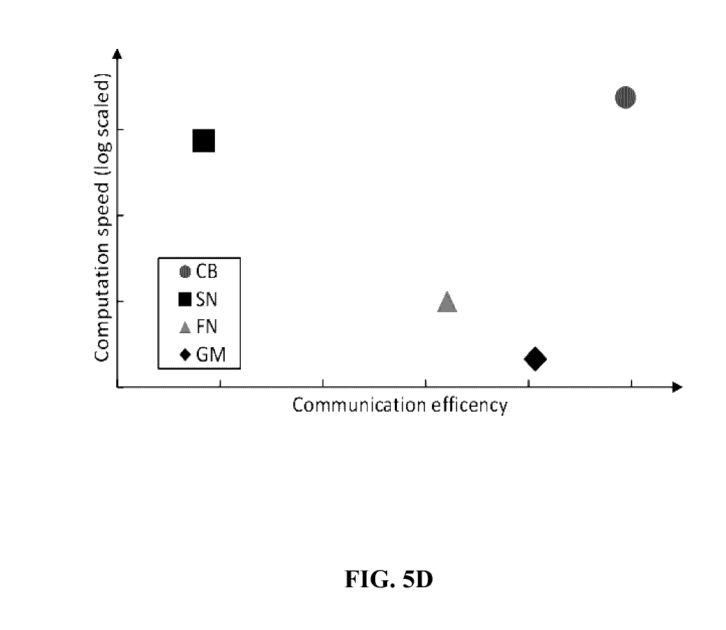

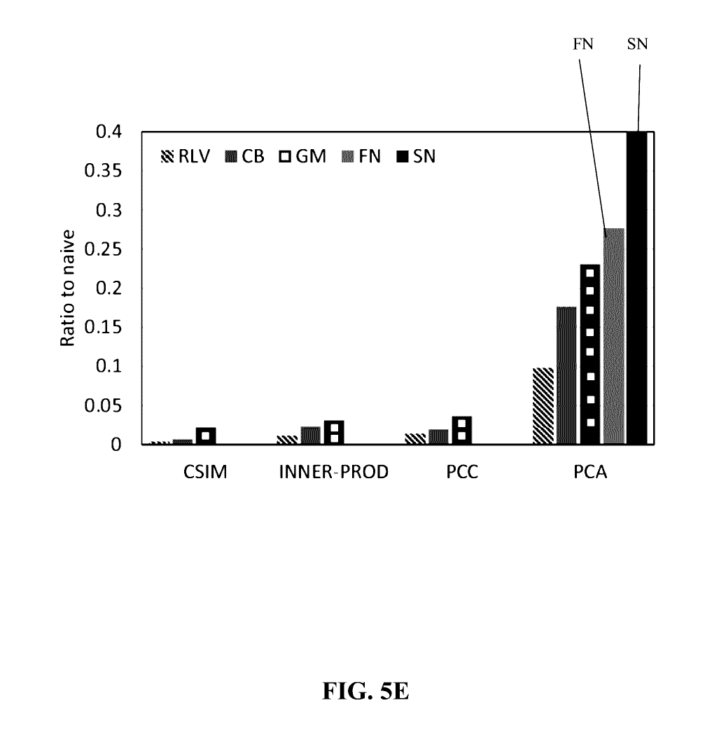

Reference is now made to FIG. 5C, which is a graph summarizing runtime times for GM and CB, using the various functions and datasets, according to some embodiments of the invention. In all cases, CB outperforms the other methods, including the GM method, a method that uses a Frobenius norm (FN) 574, and a spectral norm (SN) 572.

The number of messages sent for example monitoring functions, such as geometric monitoring (GM) and convex bounds (CB) were used to evaluate the communication cost of each method. Additionally, a naive method, in which every message is sent to the central processor, is used as a common baseline for comparison.

At the opposite extreme, a hypothetically ideal algorithm was compared, which generates a response only when the threshold condition is systemically and locally violated, such as when f(vᵢ)≧T for some local vector vᵢ and f(average(vᵢ))≧T across all nodes. A monitoring method may generate a response in such a case and adhere to the constraint f((vᵢ+ . . . +vₖ)/k)≦T. We refer to this hypothetically ideal algorithm, such as the true minimum number of responses, as real local violations (RLV). For a near-perfect algorithm, the ratio between the number of messages sent and the RLV number is close to a value of one.

Reference is now made to FIG. 5E, which is a graph summarizing communication required by CB, GM, and RLV for the functions studied as well as SN and FN for the PCA-Score function, according to some embodiments of the present invention. The y-axis is a ratio to the naïve method. Each bar of the graph represents the results across multiple thresholds and datasets. CB always performed better than GM. In most cases, CB is close to the super-optimal lower bound RLV, meaning it can hardly be improved further. Note that while FN and SN displayed better runtimes than GM (see table 582 of FIG. 5A), they have higher communication costs. CB is better than the other methods (i.e., GM, FN, SN) in both runtime and communication costs. Note that the SN bar is cropped (actual ratio is 1.4). The GM ratio for the CSIM function is based on an estimation since the runtime prohibited direct evaluation.

Following is an example of a Pearson correlation coefficient (PCC) non-convex monitoring function. Let x and y denote the frequency of appearances of two items in elements of a certain set, and z denotes the frequency of their common appearances. An example is when x and y denote the ratio of documents in which certain terms appear, and z the ratio for appearances of both terms simultaneously.

The range over which a PCC monitoring function is defined is therefore 0≦x, y≦1 and z≦x, y.

The monitoring function measures the strength of correlation between the appearances of x and y, and is defined by:

$$P ( x , y , z ) = \frac{z - xy}{\sqrt{x - {x}^{2}} \sqrt{y - {y}^{2}}}$$

The threshold T in this example is greater than zero, and the case T≦0 may be treated similarly.

The condition P(x, y, z)≦T may be written as:

z≦xy+T\sqrt{x−x²}\sqrt{y−y²}.

The PCC monitoring function may be converted to a convex form by the central processor 102 as follows. First, note that xy is neither convex nor concave. The Hessian's eigenvalues for xy are always 1 and −1, such as every point on the function's surface is a saddle point. We therefore use the identity:

$$xy = \frac{{( x + y )}^{2}}{4} - \frac{{( x - y )}^{2}}{4}$$

and denote

$${Q}_{1} = \frac{{( x + y )}^{2}}{4} , {Q}_{2} = \frac{{( x - y )}^{2}}{4} ,$$

where Q₁ and Q₂ are convex. The function \sqrt{x−x²}\sqrt{y−y²} is concave. The condition P(x, y, z)≦T may therefore be written as:

(z−T\sqrt{x−x²}\sqrt{y−y²}+Q₂)−Q₁≦0

where the last expression is the difference of two convex functions. Since \sqrt{x−x²}\sqrt{y−y²} is concave, its negative is convex. Optionally, the lower bound case is handled similarly. Calculating the tangent planes of Q₁, Q₂, and \sqrt{x−x²}\sqrt{y−y²}, defines the convex bounding function computed by the central processor 102 for the PCC monitoring function deduced by the central processor 102.

Reference is now made to FIG. 4B, which is a graph 402 of a convex upper bound function 404 for a PCC non-convex monitoring function 406 (e.g., as described above), according to some embodiments of the invention. Reference point 408 is x₀=0.3, y₀=0.6, and T=0.4. Graph 410 is a graph of a concave lower bound for the same PCC 406.

The following results compare the CB and GM example embodiments applied to the Reuters data, where every document may be labeled as belonging to several categories. For example, the most frequent category is CCAT (i.e., the CORPORATE/INDUSTRIAL category). The goal during the data collection was to select features that are most relevant to the CCAT category, i.e., who PCC with the category is above a given T. Each node holds a sliding window containing the last 6,700 documents the node received (approximately the number of documents received in a month). The correlation of CCAT with the features Bosnia and Febru was monitored.

It is noted that the majority of GM's run-time is spent on testing for sphere intersection with the PCC surface. To solve this problem the Gloptipoly global optimization package was used. In contrast, in CB, the local conditions for PCC monitoring are relatively simple, computed using the functions composing the PCC and their derivatives.

In the Reuters data, the improvement factor in run-time of checking the local condition a single time, of CB over GM is about four orders of magnitude.

Reference is now made to FIG. 5A, which is a table 582 of processing run time results of a convex bounding function compared to geometric monitoring, according to some embodiments of the invention. The table also includes results for inner product and Csim.

The Reuters data-set size was 0.8 million records, and the GM run time 502 was 284400 seconds while the CB run time 503 was 240 seconds, a 1185 factor speed increase 504.

CB performed better than GM in communication costs for all thresholds T.

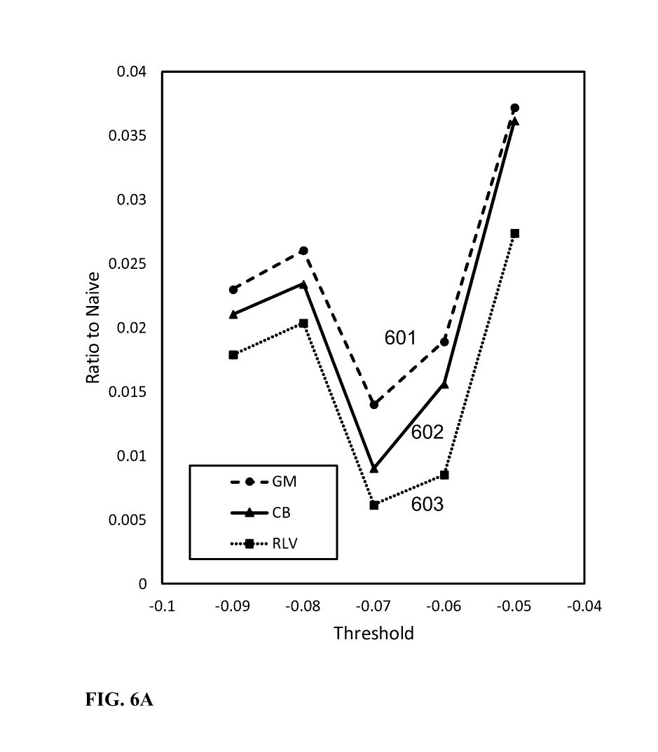

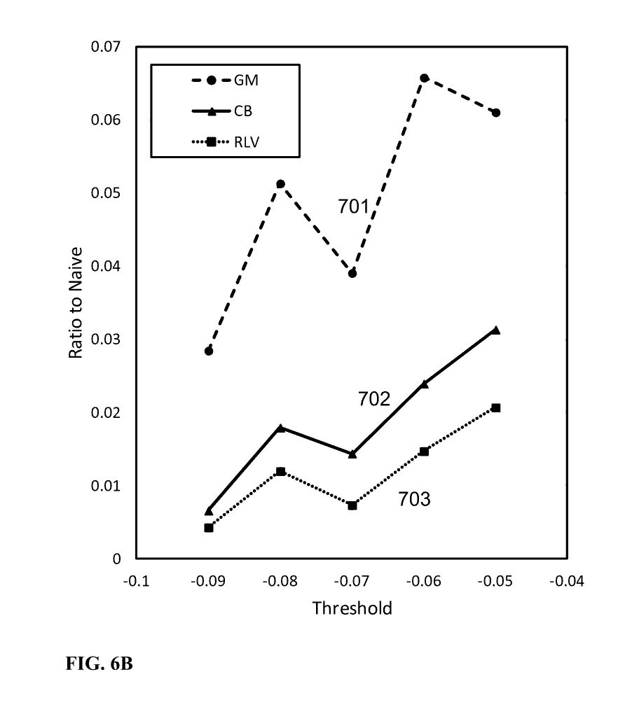

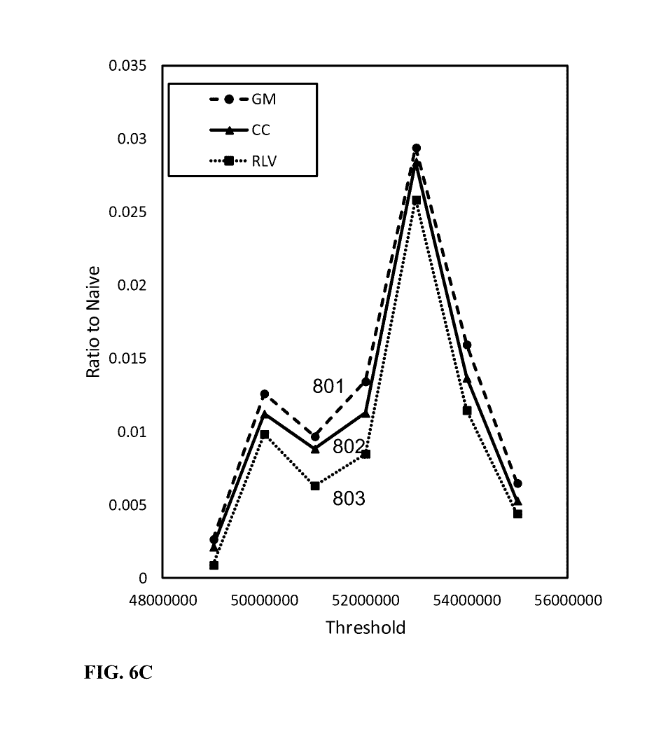

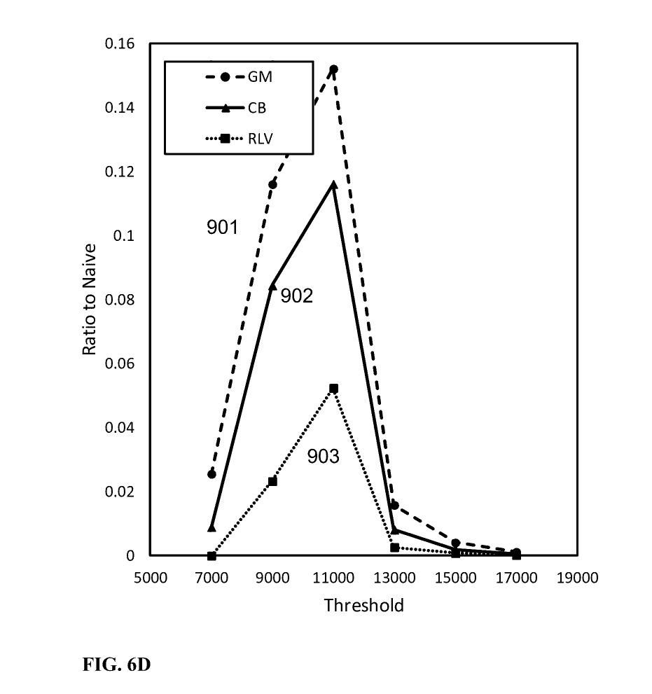

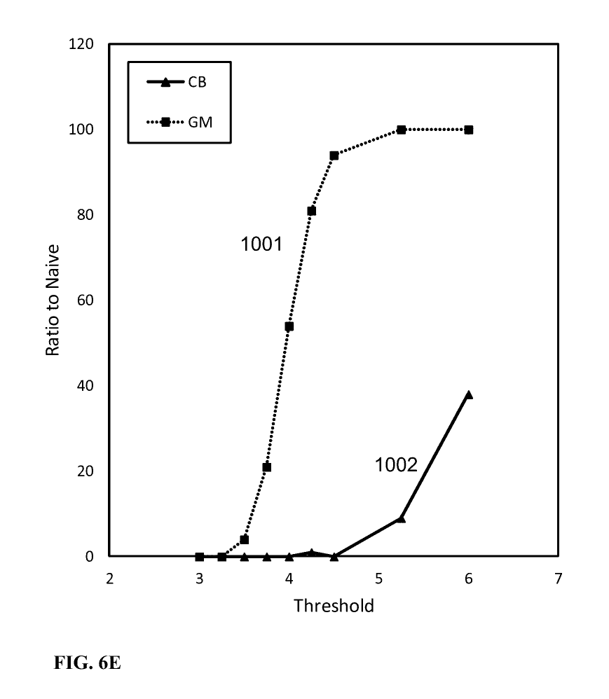

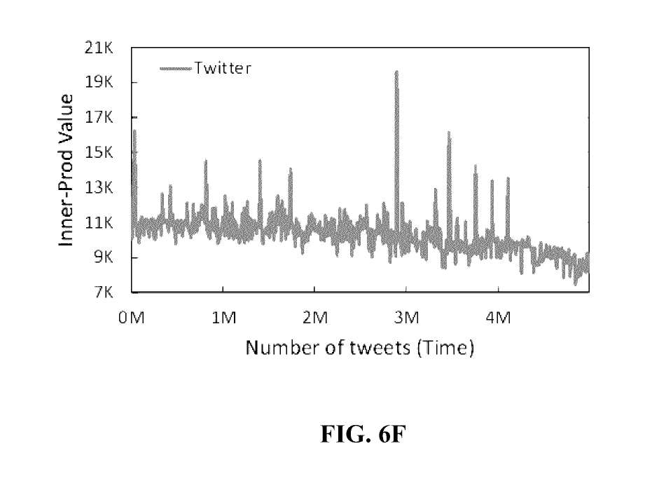

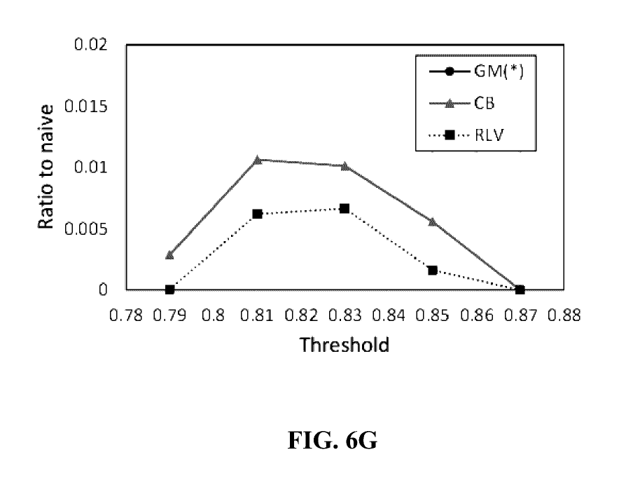

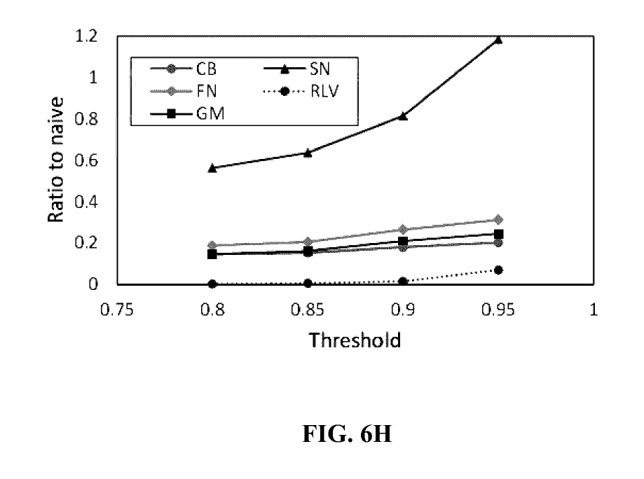

Reference is now made to FIGS. 6A and 6B, which are graphs of processing results of a convex bounding function compared to geometric monitoring for a Pearson correlation coefficient of the keywords “Febru” and “Bosnia” respectively, according to some embodiments of the invention. The advantage of CB 702 over GM 701 when monitoring “Bosnia” was larger than when monitoring “Febru”, with CB 702 typically performing two to three times better and close to RLV 703. This may be due to there being much less room for improvement for “Febru”, as indicated by the proximity of the GM 601 and CB 602 data points to the RLV 603 data points.

For the inner product case, the inner product on REU and TWIT was monitored. The inner product of feature vectors from two streams (created by splitting the records) was calculated. For REU, the top 2050 features left after removing features which appear in less than 1% of the documents were used. The NLTK package was used to tokenize and stem the tweets in TWIT, and then the top 1250 features were selected, ignoring features appearing in less than 0.1% of the tweets. In the REU experiment, each node held a sliding window of the last 6,700 documents, while in TWIT each node held a sliding window containing the last 1000 tweets.

Threshold values between 7000 and 17000 were used for TWIT, and between 4.9E7 to 5.5E7 for REU. Referring back to table 582 of FIG. 5A, it is apparent that although GM requires no optimization to find the closest point on the surface, but to solve a quadratic equation, CB checks local conditions about 20 times faster than GM, which may be due to the time required to construct and solve the equation, and then check the distinct solutions to see which one yields the closest point. Checking the local conditions requires more time for the REU, since the feature vectors are longer (2050 vs. 1250).

The computational overhead for the cosine similarity function is evaluated by monitoring both REU and TWIT. The data was the same as for the inner product experiments. Referring back to table 582 of FIG. 5A, the run-time of checking a local condition a single time in GM is almost 3 minutes, while for CB it is less than 0.2 milliseconds.

The PCA-Score function was monitored by comparing CB with GM as well as methods based on the Frobenius norm (FN) and spectral norm (SN) perturbative bounds. The other methods (i.e., except CB) require solving complex optimization problems, which were implemented using Matlab and the CVXOPT package. The PCA-Score was monitored over KC using 10 nodes, each holding a sliding window of the last 100 feature vectors. Data was collected with threshold values T ranging between 0.8 and 0.95, and effective dimension values ranging from 3 to 6.

Reference is now made to FIG. 5D, which is a graph of results indicating that the three methods which were compared with CB (i.e., SN, FN and GM) offer a trade-off between communication cost and run-time, according to some embodiments of the invention. GM achieves the best communication cost of the other three methods but is also the slowest method. FN is faster than GM but its communication cost is slightly higher. SN is the faster of the three by far, but it achieves relatively poor communication reduction. CB improves on all three methods, achieving better communication cost than GM and better run-time than SN.

Referring back to table 582 of FIG. 5A, run-time results for monitoring the PCA-score are presented. Table 582 shows an average run-time of a single round of each method the as well as the speedup factor achieved by CB.

Reference is now made to FIG. 5B, which depicts a table that summarizes the results of experiments using different segments of the data and random partitioning to nodes, to more accurately estimate the effect of the chosen function and data on the communication reduction factor of CB over GM, according to some embodiments of the invention. The average and standard deviation of the results are presented in the last column of the data. The results show that the communication reduction factor depends on both the data and the function. For example, CB reduces the communication costs by about 15-40%. It is noted that both the data and the function affect the communication cost ratio. CB is about 3 times faster than SN, two orders of magnitude faster than FN, and three orders of magnitude faster than GM.

Note that while SN runtime results are better than GMs, it achieves a rather poor reduction in communication.

Following is an example of an inner product non-convex monitoring function deduced by a central processor 102.

The inner product monitoring function may be applied in data mining and monitoring tasks as a measure of data similarity. We assume that the monitoring function f is applied to data vectors of length 2n, and is equal to the inner product of the first and second halves of the vector; denoting the concatenation of vectors x and y as [x, y], we have f([x, y])= [symbol] x, y [symbol] . To express f as the difference of two convex functions, note that 4 [symbol] x, y [symbol] =∥x+y∥²−∥x−y∥². Since the norm squared function is convex, the condition [symbol] x, y [symbol] ≦T is convexized by:

∥x+y∥²≦4T+∥x₀−y₀∥²+2 [symbol] [x₀−y₀, y₀−x₀], [x−x₀, y−y₀]

[symbol]

where the reference point p₀=[x₀, y₀], and the gradient of ∥x−y∥² is equal to 2[x−y, y−x]. For a multivariate function f, the tangent plane at a point u₀ is given by f(u₀)+ [symbol] ∇f(u₀), u−u₀ [symbol] .

As used herein, the term convexize means to convert to a convex form.

The inner product is calculated as feature vectors from two streams and/or datasets, created by splitting the records. For the Reuters dataset, the top 2050 features left after removing features that appear in less than 1% of the documents were used.

The Natural Language Toolkit package may tokenize and stem the tweets in the Twitter dataset, and the top 1250 features were selected, ignoring features appearing in less than 0.1% of the tweets.

In the Reuters example, each node held a sliding window of the last 6,700 documents, while in the twitter example each node held a sliding window containing the last 1000 tweets. Threshold values between 7000 and 17000 were used for the Twitter data, and threshold values between 4.9E+7 to 5.5E+7 were used for the Reuters data.

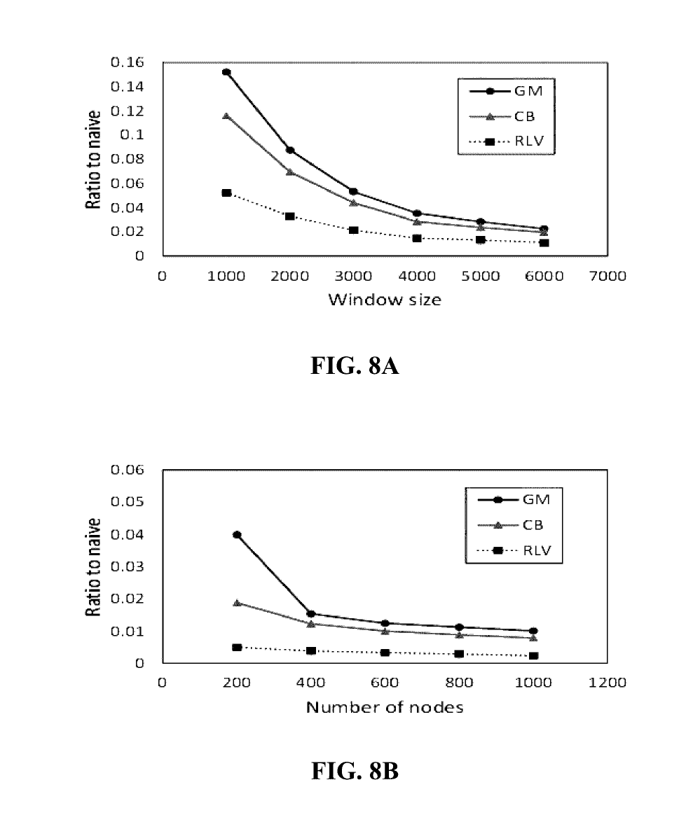

Reference is now made to FIG. 8A, which is a graph depicting the effect of the window size on the communication costs, according to some embodiments of the invention. The results are presented for the case of inner product monitoring on twitter data. The graph shows that as the window size increases, the communication costs decline. The decline in communication costs with increasing window size may be due to the slower change in the function's value.

Reference is now made to FIG. 8B, which is a graph depicting the communication cost for monitoring the inner product function on twitter data as a function of number of nodes, according to some embodiments of the invention. The graph shows that both CB and GM scale for increasing number of nodes, however CB remains closer to the RLV bound.

Reference is again made to FIG. 5A. Table 584 shows that the overall run-time advantage of CB is lower for an inner product monitoring function, but the improvement factor over GM is still up to a factor of three 504.

Reference is now made to FIGS. 6C and 6D, which are graphs of processing results of a convex bounding function compared to geometric monitoring for an inner product monitoring function of the Reuters and Twitter data respectively, according to some embodiments of the invention. CB 802 and 902 sent fewer messages than GM 801 and 901 for all threshold values of both datasets. CB 902 is about 1.3 to 2 times better than GM 901 on the Twitter data, while only about 10-25 percent better on the Reuters data, 802 and 801 respectively. Again, the proximity to the RLV graph 803 indicates that there is little room for improvement on the Reuters data, while on the Twitter data the RLV results 903 where further from the CB results 902.

Reference is now made to FIG. 6F, which is a graph of the inner product value as a function of the number of tweets (time), according to some embodiments of the invention. A comparison of FIG. 6F with FIG. 6D assists in understanding how the threshold affects the communication overhead. For example, when the threshold is equal to 11,000, the threshold is crosses many times, rendering the monitoring task more difficult. Other values (e.g., 15,000) are hardly ever crossed, rendering the monitoring task more efficient.

A popular measure of data similarity is cosine similarity, referred to hereafter as csim, which resembles the inner product monitoring function, but normalizes it by the length of the data vectors. For example, in two histograms of word frequencies, derived from two document corpora, csim normalizes the effect of the corpus size when measuring the histogram similarity, while the inner product function, however, is biased towards larger corpora.

As in the inner product example, the data vector p is [x, y], the concatenation of two n-dimensional vectors x, y, and the reference point may be denoted p₀=[x₀, y₀].

The monitoring function csim is defined by:

$$csim ( p ) = \frac{〈 x , y 〉}{‖ x ‖ ‖ y ‖} .$$

Thus, to monitor a lower bound, such as csim(p)≧T and T>0, the condition [symbol] x, y [symbol] ≧T∥x∥∥y∥ is monitored. This example is more complicated than the inner product example, since there is no obvious way to decompose it into an inequality between two convex functions. This decomposition is simple to derive for [symbol] x, y [symbol] but is more difficult to derive for ∥x∥∥y∥, which is neither convex nor concave. Therefore, the example embodiment using a Hessian operator and eigenvalues may be used to determine the convex bounding functions. The smallest eigenvalue of the Hessian (∥x∥∥y∥) equals −1.

The inequality [symbol] x, y [symbol] ≧T∥x∥∥y∥ may be written as ∥x+y∥²≧∥x−y∥²+4T∥x∥∥y∥ To make both sides convex we add 2T(∥x∥²+∥y∥²) to each side, to obtain:

∥x+y∥²+2T(∥x∥²+∥y∥²)≧∥x−y∥²+4T∥x∥∥y∥+2T(∥x∥²+∥y∥²)

The inequality may be convexized by replacing the right hand side with its tangent plane at p₀. This tangent is computing by the gradient of the function at p₀.

The csim example was evaluated with simulated data. A reference point p₀=(x₀, y₀), where x₀ and y₀ are vectors of size 100, was selected at random, and then a threshold T was selected such that csim(p₀)≦T. A noise magnitude, denoted a, is selected and 1000 data vectors are generated by adding random uniform noise in the range [−σ, σ] to every component of p₀. These vectors were used as a stream of data. We repeated the experiment for different σ values.

The run-time of checking a local condition a single time in GM is 170 seconds, while for CB it is less than 0.2 milliseconds. The GM excessive run-time prohibited monitoring cosine similarity on real data.

Reference is now made to FIG. 6E, which is a graph of processing results of a convex bounding function compared to geometric monitoring for a cosine similarity function, according to some embodiments of the invention. Both methods generate more responses as the noise increases, however CB 1002 demonstrates a clear advantage over GM 1001.

Reference is now made to FIG. 6G, which is another graph of processing results of communication cost comparison for a cosine similarity function, according to some embodiments of the invention. The GM experiments did not terminate in 24 hours, and are therefore excluded from the graph. The long run time for GM may be expected, as monitoring Csim with GM requires solving an exceedingly difficult problem. CB significantly improves over the naïve method, reducing communication by more than two orders of magnitude.

Reference is now made to FIG. 6H, which is a graph of processing results of communication cost comparison for various threshold values (KC, effective dimension 4) for different monitoring methods, according to some embodiments of the invention. The graph shows that all methods produce more communication for tighter (i.e., higher) thresholds. The advantage of the CB method is greater for tighter thresholds (e.g., 0.9 and 0.95) where the monitoring task is more difficult.

Following is yet another example application of embodiments according to the present invention. Power consumption is a critical factor, in particular in operation of mobile, battery-operated devices with limited computing resources. The computational efficiency of CB improves effective utilization of the battery, which translates into a longer lifetime of the battery. The power consumption of the computational tasks for CB versus GM was evaluated on two resource limited devices. The experiment described herein shows that the energy consumption when CB is implemented is orders of magnitude lower than the energy consumption when GM is implemented, providing additional evidence that CB may be feasibly implemented on lightweight nodes.

The experiments were conducted using a VOYO® Mini-PC and an Intel® Edison SoC (system on chip), on top of the Arduino® Expansion Board. The Intel® Edison module is a system on chip that includes an Intel® Atom™ 500 MHz dual-core CPU with 1 GB of RAM, running Yocto™ Linux. Arduino® is used to develop interactive objects, taking inputs from a variety of switches or sensors, and controlling physical outputs (such as lights and motors). VOYO® Mini-PC is a full-fledged PC designed to be used as a smart streaming media player. It features an Intel® Atom 1.33 GHz quad-core CPU, with 2 GB of RAM, and runs a Windows 32-bit operating system.

To evaluate the power consumption of each device, the devices were connected a stable power supply through a measuring device. Energy use was measured in milliwatts (mWh). The power consumption was measured for each case of a full-flow (full) and an algorithm kernel (kernel), for processing 10,000 data items.

The kernel experiments measured the checking of the local conditions. The full-flow experiments included processing a real data-stream, checking the local conditions, logging results, and communicating with the coordinator. It should be noted that while processing real data the local condition check may sometimes be avoided.

CB and GM are implemented in the Python programming language. It is noted however that GM requires using some of Matlab's® optimization packages.

Moreover, it further noted that GM' s implementation on the Mini-PC was relatively easy. However, running GM on the Edison SoC was more of a challenge, since the optimization libraries required the installation of Matlab®, and Edison is memory-constrained. As a result, only two functions were executed on the Edison SoC: inner product (which requires no optimization) and PCC, for which a light-weight Python optimization code was implemented (using coarse grid search followed by the Powell method to find the closest point on the threshold surface).

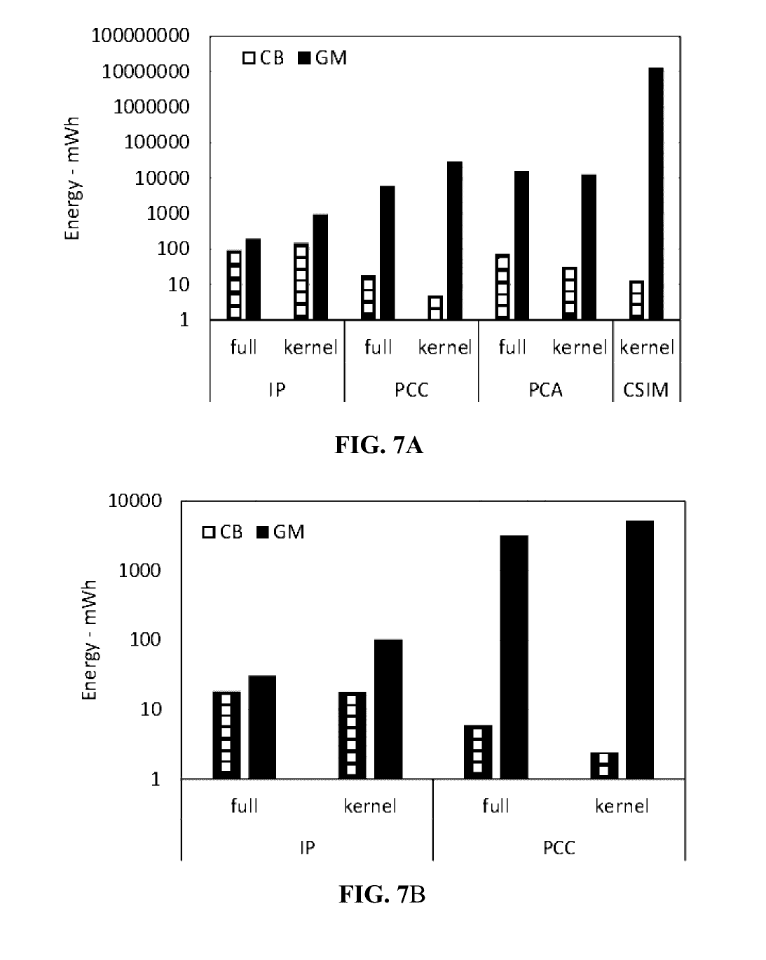

Reference is now made to FIG. 7A, which is a graph of power measurement results for the VOYO® Mini-PC, in accordance with some embodiments of the present invention. The results show that the CB kernel is orders of magnitude more power-efficient than GM, for all functions. GM's implementation for the Csim function failed to complete on real data, therefore the presented results are for the kernel experiment where synthetic 3-dimensional data is used.

Reference is now made to FIG. 7B, which is a graph of power measurements results for the Edison SoC, in accordance with some embodiments of the present invention. Recall that GM could not be implemented on the Edison SoC for the PCA and Csim functions.

It is noted that as shown in FIGS. 7A-7B, in many cases the GM-kernel uses more power than the GM-full, while the CB-kernel uses less power than the CB-full.

This observation may be explained by the fact that in some cases during the full experiment the computationally heavy local-condition check is skipped.

Following are example applications of the convex bounding function applied to data. In application to the internet of things, devices connected to the internet produce data that is monitored for a condition, and when the condition is met, a response is generated. As there are more than 11 billion devices connected to the internet, collecting data to a central computer may result in congestion and optional failure of the networking infrastructure due to network message load. Distributing a convex function that may easily compute local violations reduces the network load of data massages from the devices.

For example, traffic congestion may be reduced to improve user experience by real-time traffic flow monitoring, travel time monitoring, traffic flow control monitoring, and the like. These may involve a complex non-convex monitoring function. For example, devices connected to a municipal smart city application may be monitored to improve commuter experience, reduce pollution, optimize utilization of municipal services, and the like. For example, electrical energy generation, utilization, and consumption may be monitored in real time to optimize the electrical grid. For example, wearable internet devices may be monitored to provide security alerts, commercial opportunity alerts, and the like. For example, industrial automation devices may be monitored to improve operational efficiency, reduce process failures, and the like, by real-time monitoring and control of worldwide industrial facilities.

For example, cybersecurity attacks may be monitored by a distributed convex bounding function of sensor network infrastructure, internet of things devices, and the like.

For example, distributed web-sites may be monitored for scaling and/or prioritizing network resources. For example, distributed intrusion detection systems may use a convex bounding function to issue an intrusion alert. For example, distributed data communication applications may use a convex bounding function to issue a cybersecurity alert. For example, data streams may be monitored, such as document streams, text streams, image streams, and/or the like, to detect a patent infringement.

The benefits of using a convex bounding function for distributed processing include reduced communication overhead by sending fewer data messages that may match the monitoring condition, and simple local monitoring conditions that may be computed by local devices with less processing time than GM.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant monitoring functions will be developed and the scope of the term non-convex monitoring function is intended to include all such new technologies a priori.

It is expected that during the life of a patent maturing from this application many relevant distributed processing systems will be developed and the scope of the term distributed processing is intended to include all such new technologies a priori.

It is expected that during the life of a patent maturing from this application many relevant data streams will be developed and the scope of the term dataset, database, and/or data stream is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized device for monitoring of distributed data streams, comprising:
a network interface adapted to send processor instructions to a plurality of processing nodes; and
a central processor adapted to:
provide a non-convex function for centralized monitoring of a plurality of data streams from a plurality of processing nodes;
compute a plurality of new processor instructions defining a convex function with output values greater than or equal to output values of said non-convex function for a predefined range of input values extracted from a plurality of previously received data streams; and
send said plurality of new processor instructions to said plurality of processing nodes, wherein said plurality of processing nodes locally receive at least one of said plurality of data streams and execute said new processor instructions on a local processor to:
analyze an output value of said convex function based on said locally received data streams as input;
forward an outcome of said analysis to a centralized monitoring unit when said output value complies with a local predetermined criterion.

2. The computerized device of claim 1, wherein said central processor is further adapted to receive a plurality of processor instructions for said centralized monitoring and deduce said non-convex function from said plurality of processor instructions.

3. The computerized device of claim 1, wherein said convex function is a tangent function to said non-convex function at a data point within said predefined range.

4. The computerized device of claim 1, wherein said central processor is further adapted to perform said centralized monitoring.

5. The computerized device of claim 2, wherein said central processor is further adapted to deduce a central monitoring threshold from said plurality of processor instructions, wherein said plurality of new processor instructions further define a local threshold configured for said convex function, and wherein said local predetermined criterion is said output value of said convex function exceeding said local threshold.

6. The computerized device of claim 1, wherein said convex function comprises a linear function tangent to said non-convex function and wherein said non-convex function is a concave function within said predefined range.

7. The computerized device of claim 1, wherein said convex function comprises a second-degree polynomial function tangent to said non-convex function.

8. The computerized device of claim 1, wherein said plurality of data streams comprises at least one of a sensor network data, a social network data, a text data, a news data, a channel state information data, a stock market data, a business intelligence data, and a marketing data.

9. The computerized device of claim 1, wherein said non-convex function is at least one of a Pearson correlation coefficient function, an inner product function, a cosine similarity function, and a join aggregate function.

10. The computerized device of claim 1, wherein said non-convex function is the subtraction of a first convex monitoring function and a second monitoring convex function, and said convex function is equal to the subtraction of said first convex monitoring function and the tangent function to said second convex monitoring function.

11. The computerized device of claim 2, wherein said deducing is performed by fitting said non-convex function to an arbitrary monitoring condition defined by said plurality of processor instructions.

12. The computerized device of claim 11, wherein said fitting is a least squares fitting and said non-convex function is a polynomial function.

13. The computerized device of claim 1, wherein said non-convex function comprises a non-convex shape when viewed from above, and wherein said convex function comprises a convex shape when viewed from above.

14. The computerized device of claim 1, wherein said non-convex function is the negative of a non-concave function, wherein said non-convex function comprises a non-convex shape when viewed from below, wherein said convex function is the negative of a concave function, and wherein said convex function comprises a convex shape when viewed from below.

15. The computerized device of claim 1, wherein said convex function is selected from a plurality of convex functions by minimizing a number of false alarms for said predefined range, wherein said number of false alarms are a number of input dataset values that are incorrectly reported by said monitoring.

16. The computerized device of claim 1 wherein said plurality of data streams each comprise a set of data input values at each of a plurality of time points received at each of said plurality of processing nodes.

17. The computerized device of claim 16, wherein said set of data input values is retrieved at each of said plurality of time points from a dynamically changing database at said time point.

18. A computerized device for monitoring of distributed data streams, comprising:
a network interface adapted to receive datasets from a plurality of processing nodes, wherein each of said received data set was sent by one of said plurality of processing nodes according to processor instructions defining a convex function for locally monitoring at least one data stream; and
a central processor executing processor instructions adapted to:
receive said datasets from said plurality of processing nodes,
monitor said datasets to determine a violation of a non-convex function, and
execute a response action when said monitoring determines said violation.

19. A computer program product for monitoring of distributed data streams, the computer program product comprising a computer readable storage medium having processor instructions embodied therewith, the processor instructions executable by a computer processor to cause the computer to perform a method comprising:
providing a non-convex function for centralized monitoring of a plurality of data streams from a plurality of processing nodes;
computing a plurality of new processor instructions defining a convex function with output values greater than or equal to output values of said non-convex function for a predefined range of input values extracted from a plurality of previously received data streams; and
sending said plurality of new processor instructions to a plurality of processing nodes, wherein said plurality of processing nodes locally receive at least one of said plurality of data streams and execute said new processor instructions on a local processor to:
analyze an output value of said convex function based on said locally received data streams as input, and
forward an outcome of said analysis to a centralized monitoring unit when said output value complies with a local predetermined criterion.

20. A computerized method for monitoring of distributed data streams, comprising:
providing a non-convex function for centralized monitoring of a plurality of data streams from a plurality of processing nodes;
computing a plurality of new processor instructions defining a convex function with output values greater than or equal to output values of said non-convex function for a predefined range of input values extracted from a plurality of previously received data streams; and
sending said plurality of new processor instructions to a plurality of processing nodes, wherein each one of said plurality of processing nodes locally receives at least one of said plurality of data streams and executes said new processor instructions on a local processor to:
analyze an output value of said convex function based on said locally received data streams as input, and
forward an outcome of said analysis to a centralized monitoring unit when said output value complies with a local predetermined criterion.
